(19) United States
(12) Patent Application Publication
(10) Pub. No.: US 2025/0021877 A1
(43) Pub. Date: Jan. 16, 2025

(54) METHOD FOR CALCULATING FEASIBLE PROCESS PARAMETERS

(71) Applicant: METATECH (AP) INC., New Taipei City (TW)

(72) Inventors: YING-CHEN YANG, Taipei City (TW); Tzu-lung Sun, New Taipei City (TW); Yeong-Sung Lin, Taipei (TW); Tsung-Chi Chen, New Taipei City (TW)

(21) Appl. No.: 18/764,891

(22) Filed: Jul. 5, 2024

Related U.S. Application Data
(60) Provisional application No. 63/525,786, filed on Jul. 10, 2023.

(51) Int. Cl. G06N 20/00; G06F 17/16

(52) U.S. Cl. CPC G06N 20/00; G06F 17/16

(57) ABSTRACT

A method for calculating feasible process parameters to achieve a given process result and the method comprises the following steps of: providing a trained prediction model, obtained by machine learning of a dataset by a machine learning method, wherein the dataset comprises a plurality of samples, each of the samples comprises a plurality of sample parameters, and the trained predictive model is configured to input a plurality of input parameters and generate a prediction result corresponding to the input parameters; setting an expected result as the prediction result of the trained predictive model and providing at least one confirmed input parameters of the input parameters; and comparing the expected result, the at least one confirmed input parameters, and the sample parameters of the samples in the dataset by a reverse derivation algorithm to determine at least one non-confirmed input parameters of the input parameters.

### BACKGROUND OF THE INVENTION

### 1. Field of the Invention

The present invention relates to a method for calculating feasible process parameters and, more particularly, to a method for calculating feasible process parameters which can be applied in a cell culture process to obtain the corresponding process step according to the required process effect.

### 2. Description of the Prior Art

With the advances in biomedical engineering technology, the applications of regenerative medicine in the treatment of clinical diseases have increased. Regenerative medicine is a medical technique with wide application fields that focuses on the ability of cells to regenerate and repair damaged tissues and organs. It can also be used in combination with other medical techniques, such as tissue engineering and molecular biology, to improve and treat previously untreatable diseases such as diabetes, neurological diseases, cardiovascular diseases, and cancer. Currently, regenerative medicine is mainly applied to organ repair, immune cell therapy, and stem cell therapy. There is a growing interest in the research and application of cell therapy in regenerative medicine. Cell therapy is the process of culturing or processing cells from a human body in vitro and then transplanting the cells to the human body to replace or repair damaged tissue and/or cells.

In recent years, governments in many countries have gradually opened up the use of cell therapy, and more and more academics, both domestic and foreign, have become involved in cell therapy research, resulting in significant advances in the treatment of a wide range of diseases. For instance, autologous fibroblasts are used for treating skin defects, autologous chondrocytes for treating cartilage defects in the knee, and autologous bone marrow mesenchymal stem cells for treating spinal cord injuries. Previous studies have shown that due to the unique characteristics of each individual's cells, the types of cell preparations suitable vary from one patient to another depending on the disease and symptoms, necessitating customized cell preparations for treatment, thereby increasing the complexity and difficulty in the process. Additionally, since the quality of cell therapy products directly affects the safety and efficacy of the treatment, strict control over cell growth conditions is required in the cell culture process, along with real-time monitoring of both cell growth and environmental parameters to prevent contamination or poor quality during cultivation. However, due to high variability among cells in different cases, the optimal culture parameters and environmental parameters of cell preparations are not exactly the same in different cases. Moreover, each of the cell preparations in the process must adjust its process parameters to achieve the expected results, and it is not possible to produce each of the cell preparations with fixed process parameters. Conventional technology uses machine learning to train predictive models on large datasets of samples, and the predictive models can input various process parameters and generate predictive results for cell culture so that users can simulate the effect of their designed cell culture process in advance. However, the predictive models trained through machine learning are unable to deduce the process parameters in the cell culture process from the user's expected results. In other words, the users still need to try different process parameters when designing the cell culture process, which results in the design and improvement of the cell culture process consuming a lot of labor and resources.

Therefore, it is necessary to develop a method that can reverse the process parameters in the cell process to match the expected results and further optimize the cell process.

### SUMMARY OF THE INVENTION

In view of this, one scope of the present invention is to provide a method for calculating feasible process parameters to solve the aforementioned problems. In the present embodiment, the method for calculating feasible process parameters comprises the following steps: providing a trained predictive model, the trained predictive model is obtained by machine learning through a machine learning method on a dataset comprising a plurality of samples, each of the samples comprising a plurality of sample parameters, the trained predictive model is configured to input a plurality of input parameters and produce a predictive result corresponding to the input parameters; setting the predictive result of the trained predictive model as a target result and providing at least one confirmed input parameter in the input parameters; and comparing the target result, the at least one confirmed input parameter and the sample parameters of the samples in the dataset by a reverse inference algorithm to determine at least one unconfirmed input parameter in the input parameters.

Wherein, the dataset further comprises a process dataset, the process dataset comprises a plurality of process samples, each of the process samples comprises a plurality of process sample parameters, and each of the process sample parameters comprises a source parameter and a culture parameter.

Wherein, the source parameter of each of the process samples further comprises an attribute data from the source of each of the process samples.

Wherein, the culture parameter of each of the process samples further comprises operation, tool, material, method and environment data for each of the process samples.

Wherein, each of the sample parameters comprises at least one corresponding sample parameter and at least one unconfirmed reference parameter, and the step of comparing the target result, the at least one confirmed input parameter and the sample parameters of the samples in the dataset by the reverse inference algorithm to determine the at least one unconfirmed input parameter in the input parameters further comprises the following steps: calculating a first vector of the at least one confirmed input parameter; obtaining at least one corresponding sample parameter from the sample parameters of the samples according to the at least one confirmed input parameter; calculating a second vector of the at least one corresponding sample parameter; comparing the first vector with the second vector of each of the samples to select at least one candidate sample; combining at least one unconfirmed reference parameter of at least one candidate sample with the confirmed input parameters and inputting them into the trained predictive model to obtain a reference sample, wherein the second vector of the reference sample is close to or matches the first vector, and the predictive result of the reference sample is close to or matches the target result; and using the at least one unconfirmed reference parameter of the sample parameters of the reference sample as the at least one unconfirmed input parameter.

Wherein, the step of comparing the first vector with the second vector of each of the samples to select the at least one candidate sample further comprises the following steps: calculating an angle between the first vector and each of the second vectors of the samples and selecting the sample corresponding to the second vector with a smallest angle with the first vector as the candidate sample.

Wherein, the step of comparing the first vector with the second vector of each of the samples to select the at least one candidate sample further comprises the following steps: calculating a distance between an endpoint coordinate of the first vector and an endpoint coordinate of the second vector of each of the samples with a distance function, and selecting the sample corresponding to the second vector with the smallest distance from the first vector as the candidate sample.

Wherein, the trained predictive model is obtained through machine learning of the dataset with one of the following techniques: an Artificial Neural Network (ANN), a Convolutional Neural Network (CNN), a Recurrent Neural Network (RNN), a Decision Tree, a Support Vector Machine (SVM), a Random Forest, a K-Nearest Neighbors (KNN) algorithm, a K-Means Clustering, a Principal Component Analysis (PCA), a Linear Regression, a Logistic Regression, a Gradient Boosting Machine, a Deep Belief Network (DBN), a Recursive Neural Network (RecNN), Reinforcement Learning, an Autoencoder, a Gaussian Process, and a Complex Neural Network.

Wherein, the step of comparing the target result, the at least one confirmed input parameter and the sample parameters of the samples in the dataset by the reverse inference algorithm to determine the at least one unconfirmed input parameter in the input parameters further comprises the following steps: comparing the target result, the at least one confirmed input parameter and the sample parameters of the samples in the dataset by the reverse inference algorithm, identifying the sample parameters of a first reference sample in the samples as a reference input parameter, wherein the reference input parameter comprises at least one unconfirmed reference parameter; inputting the at least one confirmed input parameter and the at least one unconfirmed reference parameter into the trained predictive model to generate a reference predictive result; comparing the reference predictive result with the target result; and determining the at least one unconfirmed reference parameter as the at least one unconfirmed input parameter when the reference predictive result matches the target result.

Wherein, the method for calculating feasible process parameters further comprises the following step: when the reference predictive result does not match the target result, excluding the first reference sample and again comparing the target result, the at least one confirmed input parameter and the sample parameters of the samples in the dataset by the reverse inference algorithm to obtain the sample parameters of a second reference sample in the samples as the reference input parameter.

Wherein, the method for calculating feasible process parameters further comprises the following steps: comparing the at least one corresponding sample parameter of the samples in the dataset, inputting the at least one confirmed input parameter and the at least one unconfirmed reference parameter corresponding to each of the samples into the trained predictive model to generate the reference predictive result corresponding to the samples; comparing the reference predictive result corresponding to each of the samples with the target result to identify the reference sample whose reference predictive result matches the target result, further forming a reference sample set.

Wherein, the method for calculating feasible process parameters further comprises the following steps: performing a linear combination of the first K data from the reference sample set to find an optimal combination of unconfirmed input parameters using an optimization search method.

Another scope of the present invention is to provide a method for calculating feasible process parameters. In the present embodiment, the method for calculating feasible process parameters comprises the following steps of: providing a trained predictive model, the trained predictive model being obtained by machine learning through a machine learning method on a dataset comprising a plurality of samples, each of the samples comprising a plurality of sample parameters, the trained predictive model being configured to input a plurality of input parameters and produce a predictive result corresponding to the input parameters; setting the predictive result of the trained predictive model as a target result and providing at least one confirmed input parameter in the input parameters, wherein each of the sample parameters comprises at least one corresponding sample parameter corresponding to the at least one confirmed input parameter and at least one unconfirmed reference parameter; inputting the sample parameters of at least one of the samples to the trained predictive model to obtain at least one candidate sample, wherein the predictive result of the at least one candidate sample is close to or matches the target result; calculating a first vector of the at least one confirmed input parameter and a second vector of the at least one corresponding sample parameter of the at least one candidate sample; comparing the first vector with the second vector to select a reference sample, wherein the second vector of the reference sample is close to or matches the first vector; and using the at least one unconfirmed reference parameter of the sample parameters of the reference sample as the at least one unconfirmed input parameter.

Another scope of the present invention is to provide a method for calculating feasible process parameters. In the present embodiment, the method for calculating feasible process parameters comprises the following steps of: providing a trained predictive model, the trained predictive model being obtained by machine learning through a machine learning method on a dataset comprising a plurality of samples, each of the samples comprising a plurality of sample parameters, the trained predictive model being configured to input a plurality of input parameters and produce a predictive result corresponding to the input parameters; setting the predictive result of the trained predictive model as a target result and providing at least one confirmed input parameter in the input parameters, wherein each of the sample parameters comprises at least one corresponding sample parameter corresponding to the at least one confirmed input parameter and at least one unconfirmed reference parameter; calculating a first vector of the at least one confirmed input parameter; obtaining the at least one corresponding sample parameter from the sample parameters of the samples according to the at least one confirmed input parameter; calculating a second vector of the at least one corresponding sample parameter; comparing the first vector with the second vector of each of the samples to select at least one candidate sample, wherein the second vector of the at least one candidate sample is close to or matches the first vector; inputting the sample parameters of the at least one candidate sample to the trained predictive model to obtain a reference sample, wherein the predictive result of the reference sample is close to or matches the target result; and using the at least one unconfirmed reference parameter of the sample parameters of the reference sample as the at least one unconfirmed input parameter.

Another scope of the present invention is to provide a method for calculating feasible process parameters. In the present embodiment, the method for calculating feasible process parameters comprises the following steps of: providing a trained predictive model, the trained predictive model being obtained by machine learning through a machine learning method on a dataset comprising a plurality of samples, each of the samples comprising a plurality of sample parameters, each of the sample parameters comprising at least one corresponding sample parameter and at least one unconfirmed reference parameter, the trained predictive model being configured to input a plurality of input parameters and produce a predictive result corresponding to the input parameters; setting the predictive result of the trained predictive model as a target result and providing at least one confirmed input parameter in the input parameters; combining the at least one confirmed input parameter with the at least one unconfirmed reference parameter of each of the sample parameters and inputting them to the trained predictive model to obtain a reference sample, wherein the predictive result of the reference sample is close to or matches the target result; and using the at least one unconfirmed reference parameter of the sample parameters of the reference sample as the at least one unconfirmed input parameter.

In summary, the present invention provides a method for calculating feasible process parameters that effectively optimizes the process and achieves the target result of the process by inputting the expected target result and the confirmed input parameters and inverting the unconfirmed input parameters through the dataset of the trained predictive model. Furthermore, the present invention provides a method for calculating feasible process parameters that can be applied to any trained machine learning model to invert its process parameters and unconfirmed input parameters, in addition to its application in the field of cell process.

### BRIEF DESCRIPTION OF THE APPENDED DRAWINGS

FIG. 1 is a flowchart diagram illustrating a method for calculating feasible process parameters according to an embodiment of the present invention.

FIG. 2 is a block diagram illustrating the dataset and samples in the method for calculating feasible process parameters according to an embodiment of the present invention.

FIG. 3 is a flowchart diagram illustrating a method for calculating feasible process parameters according to an embodiment of the present invention.

FIG. 4 is a flowchart diagram illustrating a method for calculating feasible process parameters according to another embodiment of the present invention.

FIG. 5 is a flowchart diagram illustrating a method for calculating feasible process parameters according to another embodiment of the present invention.

FIG. 6 is a flowchart diagram illustrating a method for calculating feasible process parameters according to another embodiment of the present invention.

FIG. 7 is a block diagram illustrating the dataset and samples in the method for calculating feasible process parameters according to another embodiment of the present invention.

FIG. 8 is a flowchart diagram illustrating a method for calculating feasible process parameters according to another embodiment of the present invention.

FIG. 9 is a flowchart diagram illustrating a method for calculating feasible process parameters according to another embodiment of the present invention.

FIG. 10 is a flowchart diagram illustrating a method for calculating feasible process parameters according to another embodiment of the present invention.

FIG. 11 is a flowchart diagram illustrating a method for calculating feasible process parameters according to another embodiment of the present invention.

### DETAILED DESCRIPTION OF THE INVENTION

For the sake of the advantages, spirits, and features of the present invention can be understood more easily and clearly, the detailed descriptions and discussions will be made later by way of the embodiments and with reference to the diagrams. It is worth noting that these embodiments are merely representative embodiments of the present invention, wherein the specific methods, devices, conditions, materials, and the like are not limited to the embodiments of the present invention or corresponding embodiments. Moreover, the devices in the figures are only used to express their corresponding positions and are not drawn according to their actual proportion.

In the description of this specification, the description with reference to the terms “an embodiment”, “another embodiment”, or “part of an embodiment” means that a particular feature, structure, material, or characteristic described in connection with the embodiment, including in at least one embodiment of the present invention. In this specification, the schematic representations of the above terms do not necessarily refer to the same embodiment. Furthermore, the particular features, structures, materials, or characteristics described may be combined in any suitable manner in one or more embodiments. Furthermore, the indefinite articles “a” and “an” preceding a device or element of the present invention are not limited to the quantitative requirement (the number of occurrences) of the device or element. Thus, “a” should be read to include one or at least one, and a device or element in the singular also includes the plural unless the number clearly refers to the singular.

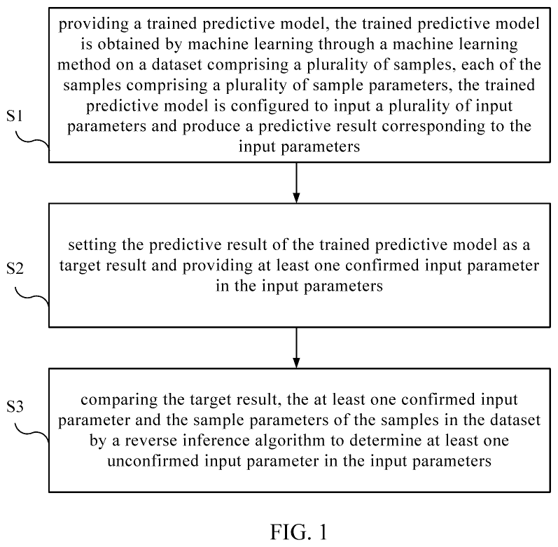

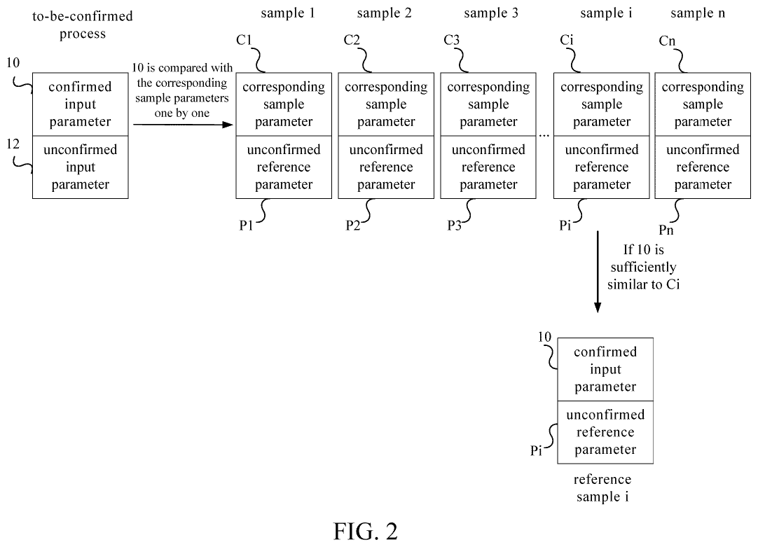

Please refer to FIG. 1 and FIG. 2. FIG. 1 is a flowchart diagram illustrating a method for calculating feasible process parameters according to an embodiment of the present invention. FIG. 2 is a block diagram illustrating the dataset and samples in the method for calculating feasible process parameters according to an embodiment of the present invention. As shown in FIG. 1, the method for calculating feasible process parameters in the present embodiment includes step S1: providing a trained predictive model, the trained predictive model is obtained by machine learning through a machine learning method on a dataset comprising a plurality of samples (comprising sample 1 to sample n), each of the samples comprising a plurality of sample parameters, the trained predictive model is configured to input a plurality of input parameters and produce a predictive result corresponding to the input parameters; step S2: setting the predictive result of the trained predictive model as a target result and providing at least one confirmed input parameter 10 in the input parameters; and step S3: comparing the target result, the at least one confirmed input parameter 10 and the sample parameters of the samples in the dataset by a reverse inference algorithm to determine at least one unconfirmed input parameter 12 in the input parameters.

In the present embodiment, the trained predictive model in Step S1 can be either a model obtained from a public platform trained through machine learning techniques or a model trained by the user. Furthermore, the dataset in the present embodiment can be used for any data collection for training, testing, and validating machine learning models. In practical applications, the method for calculating feasible process parameters of the present embodiment can be applied to any other trained machine learning model, utilizing confirmed input parameters to match database data and combining confirmed input parameters with unconfirmed reference parameters to infer unconfirmed input parameters. In addition, the trained predictive model in the present embodiment can utilize various machine learning or neural network algorithms according to user needs. These include an Artificial Neural Network (ANN), a Convolutional Neural Network (CNN), a Recurrent Neural Network (RNN), a Decision Tree, a Support Vector Machine (SVM), a Random Forest, a K-Nearest Neighbors (KNN) algorithm, a K-Means Clustering, a Principal Component Analysis (PCA), a Linear Regression, a Logistic Regression, a Gradient Boosting Machine, a Deep Belief Network (DBN), a Recursive Neural Network (RecNN), Reinforcement Learning, an Autoencoder, a Gaussian Process, and a Complex Neural Network, or other machine learning algorithms or neural network algorithms to perform machine learning on the dataset.

In the present embodiment, the dataset further comprises a process dataset, the process dataset comprises a plurality of process samples, each of the process samples comprises a plurality of process sample parameters, and each of the process sample parameters comprises a source parameter and a culture parameter. When the method for calculating feasible process parameters of the present embodiment is applied to cell culture processes, the process dataset can be a cell dataset. In practice, the cell dataset can be obtained from any public platform or collected by the user. In addition, the types of the cell samples can include immune cells (such as dendritic cells (DC cells), cytokine-induced killer cells (CIK), tumor-infiltrating lymphocytes (TIL), natural killer cells (NK cells), and CAR-T cells), stem cells (such as peripheral blood stem cells, adipose stem cells, and bone marrow mesenchymal stem cells), chondrocytes, fibroblasts, etc. In practice, it is not limited to the aforementioned, and it can be decided according to the type of cell culture that the user needs to perform. Moreover, in the present embodiment, the source parameter of each of the process samples can further comprise attribute data of a source of each of the process samples. Each of the cell samples in the cell dataset can comprise information about the source associated with the cell and the attribute data of the source, and the attribute data can be physiological data or other relevant data about the source, such as gender, age, medical history, living environment, geographical area of residence. In practice, it is not limited to the aforementioned; the source parameter of the cell samples can further include other parameters that can influence the cell process and are related to the origin of the cells.

Furthermore, in the present embodiment, the culture parameter of each of the process samples further comprises operation, tool, material, method, and environment data for each of the process samples. The cell culture process comprises many steps, and each of the steps can include numerous culture parameters. The parameters include those related to people (operation), such as the gender and age of the cell source, the experience and consistency of the cell culture operator, and the personnel, location, environment, and transportation variances associated with the surgical procedure. The parameters include those related to machinery (tool), such as the type and grade of the cell operation platform and the stability and accuracy of temperature and humidity control in the cell culture incubators. The parameters include those related to material, such as the material of the cell culture dishes and the components and ratios of the cell culture medium. The parameters include those related to the method, such as the techniques of the cell culture operators and the methods of the cell culture process. The parameters include those related to the environment, such as the ambient temperature, humidity, carbon dioxide concentration, and concentration of organic molecules in the cell culture environment.

The method for calculating feasible process parameters of this embodiment identifies unconfirmed process parameters in the process to be recognized by comparing the dataset used to generate the trained predictive model through a reverse derivation algorithm. In detail, if the trained model used by the user demonstrates excellent predictive performance, while the predictive result alone does not allow for inferring the input process parameters based on the trained model, the model is developed through machine learning applied to the dataset. Therefore, the process parameter data within the dataset can serve as a basis for deducing the process parameters.

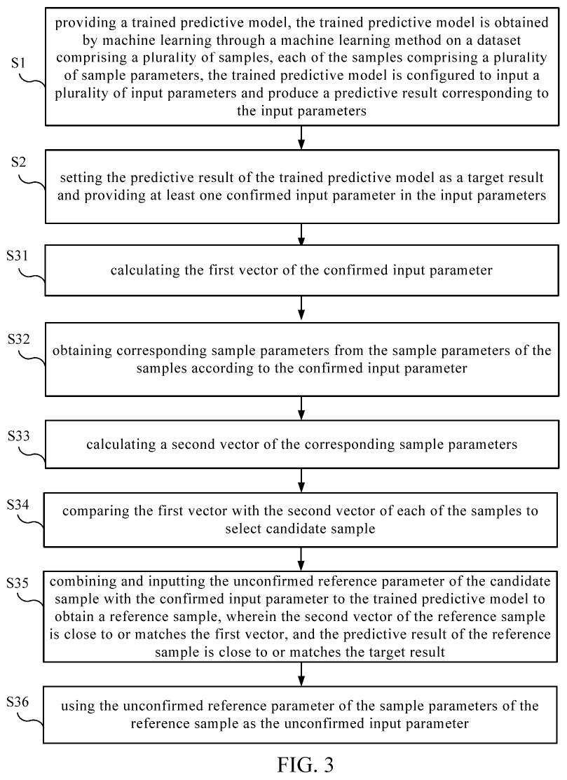

Please refer to FIG. 1, FIG. 2 and FIG. 3. FIG. 3 is a flowchart diagram illustrating a method for calculating feasible process parameters according to an embodiment of the present invention. Further explanation of the present embodiment will be provided in FIG. 3. In this embodiment, each of the sample parameters comprises at least one corresponding sample parameter and at least one unconfirmed reference parameter. As shown in FIG. 3, step S3 of the method for calculating feasible process parameters in the present embodiment includes steps S31, S32, S33, S34, S35, and S36, which are sequentially executed following step S2. Step S31: calculating the first vector of the confirmed input parameter 10; step S32: obtaining corresponding sample parameters C1 to Cn from the sample parameters of the samples according to the confirmed input parameter 10; step S33: calculating a second vector of the corresponding sample parameters C1 to Cn; step S34: comparing the first vector with the second vector of each of the samples to select candidate sample i (i.e., Sample i); step S35: combining and inputting the unconfirmed reference parameter Pi of the candidate sample i with the confirmed input parameter 10 to the trained predictive model to obtain a reference sample i, wherein the second vector of the reference sample i is close to or matches the first vector, and the predictive result of the reference sample i is close to or matches the target result, and step S36: using the unconfirmed reference parameter Pi of the sample parameters of the reference sample i as the unconfirmed input parameter 12.

As shown in FIG. 1, FIG. 2, and FIG. 3, a to-be-confirmed process can include both a cultured stage and a to-be-cultured stage (not shown in the figures), and corresponding to the cultured stage and the to-be-cultured stage, the to-be-confirmed process further includes cultured process parameters (i.e., the confirmed input parameter 10) and to-be-cultured process parameters (i.e., the unconfirmed input parameter 12). In this embodiment, the dataset can contain process parameter data related or similar in terms of culture time and process to that of the to-be-confirmed process, which serves as the basis for deducing the unconfirmed input parameters 12. The dataset includes samples from Sample 1 to Sample n, wherein each of the samples contains sample parameters (not shown in the figures), and the sample parameters further include corresponding sample parameters C1 to Cn and unconfirmed reference parameters P1 to Pn. For example, if a user intends to conduct a 21-day process and has already completed a 7-day segment of the process (i.e., the user already has confirmed input parameters 10), but the parameters for days 8 to 21 are yet to be confirmed or adjusted (i.e., the unconfirmed input parameters 12) to achieve the expected target result by the preset day 21.

In the present embodiment, the reverse derivation algorithm in step S3 first compares the confirmed input parameters 10, which correspond to the initial 7 days completed by the user, with the corresponding sample parameters C1 to Cn for the first 7 days of all samples (i.e., Sample 1 to Sample n) in the dataset. This comparison is configured to select candidate sample from the dataset. The unconfirmed reference parameters of the candidate sample are combined with the confirmed input parameters 10 of the to-be-confirmed process to form reference samples. The reference samples are input to the trained predictive model to confirm whether the reference samples meet the expected target result. If the reference samples meet the expected target result, the unconfirmed reference parameters of the reference samples can be used as the unconfirmed input parameters 12 for the to-be-confirmed process. For example, if the comparison of the confirmed input parameter 10 with all corresponding sample parameters C1 to Cn from Sample 1 to Sample n shows that the corresponding sample parameters Ci of Sample i are the closest match or comply with the confirmed input parameter 10, then the unconfirmed reference parameters Pi of Sample i, combined with the confirmed input parameter 10, form reference sample i. All parameters of reference sample i are then entered into the trained predictive model. If the predictive results are equal to or better than the target result, then the unconfirmed reference parameters Pi can be used as the unconfirmed input parameters 12 for the process from day 8 to day 21. In the present embodiment, the selection of the candidate sample can be further refined by calculating an angle between the first vector and each of the second vectors of the samples and selecting the sample corresponding to the second vector with the smallest angle with the first vector as the candidate sample. Moreover, in practice, the to-be-confirmed process can consist only of the to-be-cultured stage without the cultured stage and only include corresponding to-be-cultured process parameters (i.e., the unconfirmed input parameter 12), and the first vector in this embodiment is an empty vector.

In the described embodiment, step S3 involves comparing the confirmed input parameters with the sample parameters of the samples in the dataset to identify suitable samples, which then inform the determination of the process parameters for days 8 to 21 (unconfirmed input parameter 12). Further explanation on how to match suitable samples using confirmed input parameters will now be provided. Please refer to FIG. 2 and FIG. 3. As shown in FIG. 3, the present embodiment uses the first vector of the confirmed input parameters 10 of the to-be-confirmed process to compare with the second vectors of the corresponding sample parameters C1 to Cn from all samples (sample 1 to sample n) in the dataset. Wherein, when the second vector of sample i is close to or matches the first vector of the confirmed input parameter 10 of the to-be-confirmed process (i.e., the angle between the two vectors is close to or at 0 degrees), and sample i is input to the trained predictive model and obtains a predictive result that is equal to or exceeds the target result, then sample i can be used as the reference sample i. Then, the user can use the sample parameter other than the corresponding sample parameter of the reference sample i (i.e., the unconfirmed reference parameter Pi) as the unconfirmed input parameter 12.

Additionally, in the present embodiment, during the execution of step S34, which involves comparing the first vector of the confirmed input parameters 10 of the to-be-confirmed process with the second vectors of each of the samples, let's assume that the second vector of sample 1 does not close to or match with the first vector (i.e., the angle between the two vectors is not close to 0 degrees), or if sample 1, once entered to the trained predictive model, yields predictive results that do not satisfy the target result, then sample 1 is excluded. The procedure then iterates from step S32 to step S35 with other samples in the dataset until a sample close to or matches the criteria is found. Given that the parameters have been validated for excellent predictive performance within the trained model, the users can expect to achieve the target results by continuing the subsequent process steps using the unconfirmed input parameters obtained through this method after completing the confirmed process steps. In practice, the users can adjust and set the criteria for closeness and conformity based on different situations and needs. Note that the other steps in the method for calculating feasible process parameters of the present embodiment are substantially similar to those described in the previous embodiments and would not be described again herein.

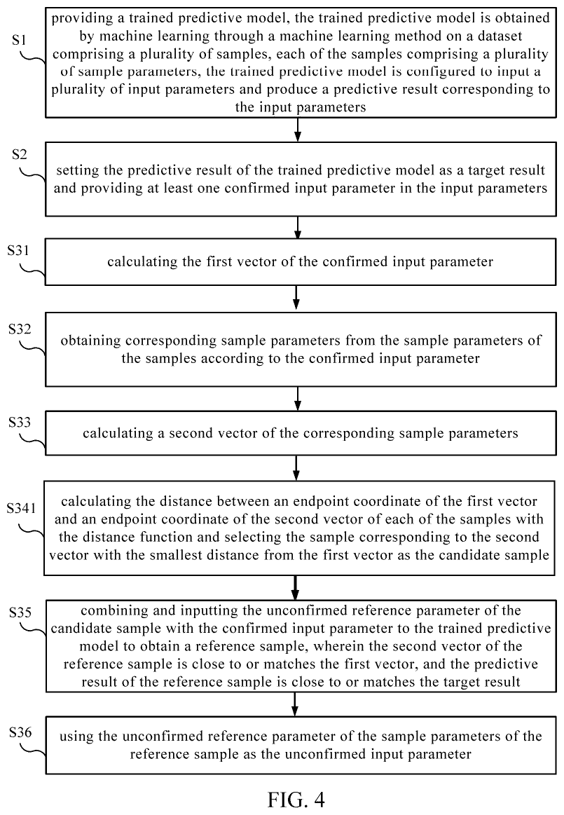

In addition to the aforementioned embodiments, the invention provides another method for selecting candidate samples. Please refer to FIG. 4. FIG. 4 is a flowchart diagram illustrating a method for calculating feasible process parameters according to another embodiment of the present invention. This embodiment can further include step S341, executed sequentially after step S33. Step S341: calculating the distance between an endpoint coordinate of the first vector and an endpoint coordinate of the second vector of each of the samples with a distance function and selecting the sample corresponding to the second vector with the smallest distance from the first vector as the candidate sample. In practice, the distance functions commonly used in machine learning include Euclidean distance, Manhattan distance, Cosine similarity, Jaccard similarity, and Mahalanobis distance. In practice, the calculation of the minimum distance and the applicable range of the minimum distance can be set according to the user's requirements. Note that the other steps in the method for calculating feasible process parameters of the present embodiment are substantially similar to those described in the previous embodiments and would not be described again herein.

As described in the aforementioned embodiments, it is possible to provide a trained predictive model that performs more efficient computation and processing by vectorizing the parameters concentrated in the dataset. However, in practice, vectorizing the parameters in the dataset to determine the reference samples involves not only calculating the angle between the first vector and the second vector and the distance between the vectors as mentioned above, but also selecting other vector calculation methods or comparison methods based on user needs, the intended application scenarios, and the type of dataset, to determine the reference samples.

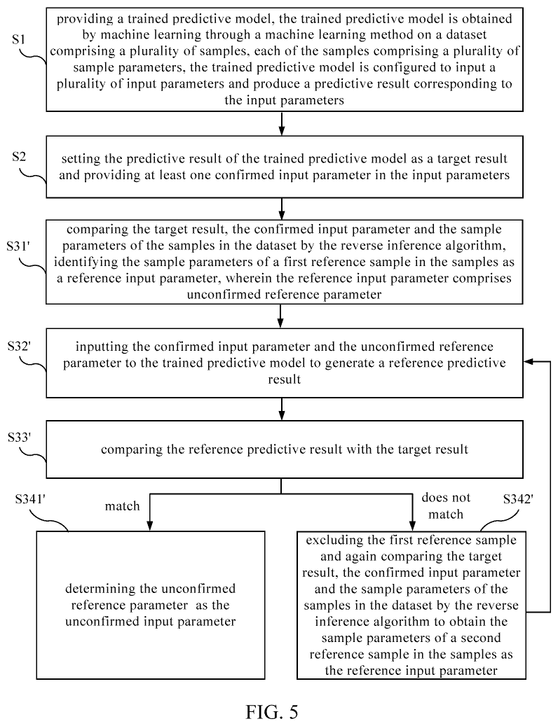

The embodiments described above involve vectorizing the parameters within the dataset and determining unconfirmed input parameters by comparing the angles and distances between parameters to find the reference samples that match or are suitable for the confirmed input parameters. However, if no compatible or suitable reference sample can be obtained by comparing the angles and distances between the parameters, or if the resulting angles and distances are outside the range of the preset minimum angles and distances, then other comparisons can be made to obtain a more suitable reference sample. Please refer to FIG. 5. FIG. 5 is a flowchart diagram illustrating a method for calculating feasible process parameters according to another embodiment of the present invention. As shown in FIG. 5, the present embodiment differs from the previous embodiment in that the method for calculating feasible process parameters of the present embodiment further comprises step S31′, step S32′, step S33′, step S341′ and step S342′, which are performed sequentially after step S2. Step S31′: comparing the target result, the confirmed input parameter 10 and the sample parameters of the samples in the dataset by the reverse inference algorithm, identifying the sample parameters of a first reference sample in the samples as a reference input parameter, wherein the reference input parameter comprises unconfirmed reference parameter; step S32′: inputting the confirmed input parameter 10 and the unconfirmed reference parameter to the trained predictive model to generate a reference predictive result; step S33′: comparing the reference predictive result with the target result; step S341′: determining the unconfirmed reference parameter P1 as the unconfirmed input parameter 12 when the reference predictive result matches the target result; step S342′: when the reference predictive result does not match the target result, excluding the first reference sample and again comparing the target result, the confirmed input parameter and the sample parameters of the samples in the dataset by the reverse inference algorithm to obtain the sample parameters of a second reference sample in the samples as the reference input parameter.

In the present embodiment, the reference predictive result of the complete parameter vector formed by the first vector of the confirmed input parameter 10 and the unconfirmed reference parameter P1 to Pn of each of the samples (sample 1 to sample n) are evaluated in a sequential manner in order to obtain a more suitable reference sample. For example, during a 21-day culture process, if the user has completed the first 7 days of the process (i.e., the confirmed input parameters 10) and needs to confirm the process parameters for the subsequent days from day 8 to day 21 (i.e., the unconfirmed input parameters 12) to achieve a target result of 95% cell viability on the 21st day. However, suppose the user cannot find matching or suitable reference samples using the angle and distance between parameters to achieve the expected target result for the unconfirmed input parameters 12. In that case, further steps can be taken as follows. In practice, first, a reverse derivation algorithm is used to match the target results, the confirmed input parameters, and the sample parameters from the dataset, and samples are then ordered based on how closely their first and second vectors align. Subsequently, following this order, the complete parameter formed by the combination of the confirmed input parameter 10 and unconfirmed reference parameters from each of the samples are sequentially inputted to the trained predictive model to generate the reference predictive results and further compare the reference predictive results with the target result. If the reference predictive result of the first reference sample, which is ranked first, matches the target result (95% cell viability), then the unconfirmed reference parameters of the first reference sample can be decided as the unconfirmed input parameters 12. Suppose the reference predictive result of the first reference sample does not meet the target result (95% cell viability). In that case, the first reference sample is excluded, and the unconfirmed reference parameters of the subsequent samples are sequentially combined with the confirmed input parameters 10 and entered into the trained predictive model until a reference sample (the second reference sample) is found whose reference predictive results match the target result (95% cell viability).

Furthermore, in practice, if a match for cell reference samples with reference predictive results that meet the target result (95% cell viability) still cannot be found, the matching process can be terminated. In practice, the users can further adjust and set appropriate indicators based on different situations and their needs. If matching through the reverse derivation algorithm does not yield cell reference samples whose reference predictive results meet the target result (95% cell viability), then this matching process will be terminated. Alternatively, adjustments could be made to the target result (e.g., adjusting the cell viability from 95% to 93%), or the goal could be changed to match the predictive result of a process reference sample closest to the target result. The present embodiment uses a reverse derivation algorithm to automatically match sample parameters in the dataset and deduce the process parameters needed to achieve the expected target result, thereby effectively optimizing the method and achieving the target result of the process. Note that the other steps in the method for calculating feasible process parameters of the present embodiment are substantially similar to those described in the previous embodiments and would not be described again herein.

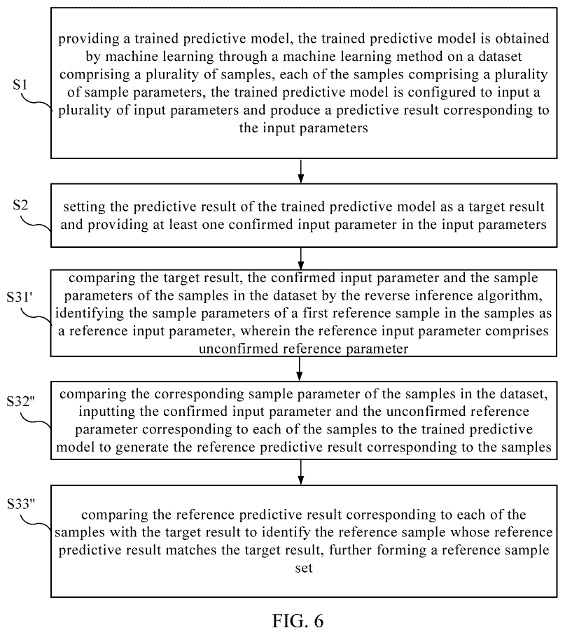

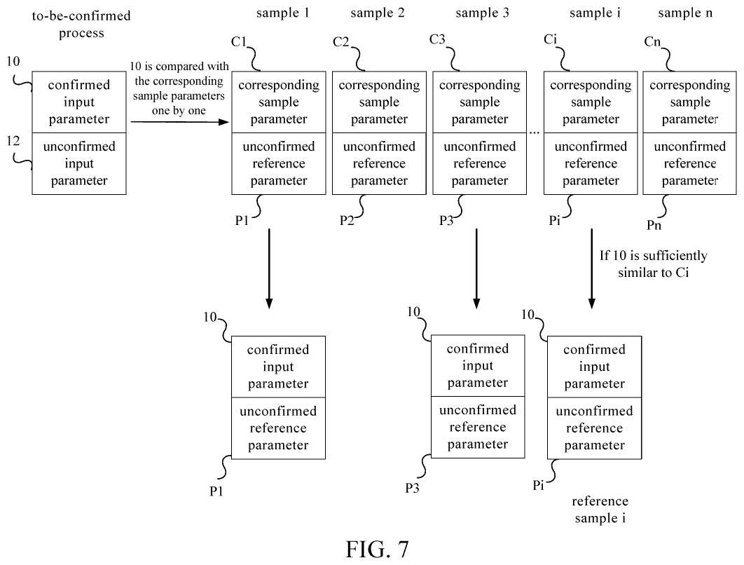

Moreover, the invention can also be used to form a set of process reference samples by comparing the sample parameters of all the process samples in the process data set in a one-time mass comparison to find the process reference samples whose reference predictive result meets the target result (95% cellular activity) and further filtering to select the optimal combination of unconfirmed input parameters. Please refer to FIG. 6 and FIG. 7. FIG. 6 is a flowchart diagram illustrating a method for calculating feasible process parameters according to another embodiment of the present invention. FIG. 7 is a block diagram illustrating the dataset and samples in the method for calculating feasible process parameters according to another embodiment of the present invention. As shown in FIG. 6, the method in the present embodiment differs from the previous embodiments in that the method in the present embodiment can further include step S32″ and step S33″, executed sequentially after step S31′. Step S32″: comparing the corresponding sample parameter C1 to Cn of the samples (including sample 1 to sample n) in the dataset, inputting the confirmed input parameter 10 and the unconfirmed reference parameter (including P1 to Pn) corresponding to each of the samples to the trained predictive model to generate the reference predictive result corresponding to the samples; step S33″: comparing the reference predictive result corresponding to each of the samples with the target result to identify the reference sample whose reference predictive result matches the target result, further forming a reference sample set. In the present embodiment, by performing a one-time comparison of sample parameters for all process samples in the dataset, one or more process reference samples whose reference predictive results meet the target result (95% cell viability) can be identified, forming a set of cell reference samples. According to the user-defined conditions, selections are made from the set of process reference samples for the unconfirmed input parameters 12. In practice, the users can set conditions based on their inventory of consumables and cost considerations and choose process parameters from the reference sample set that meet the target result and the user requirements. Note that the other steps in the method for calculating feasible process parameters of the present embodiment are substantially similar to those described in the previous embodiments and would not be described again herein.

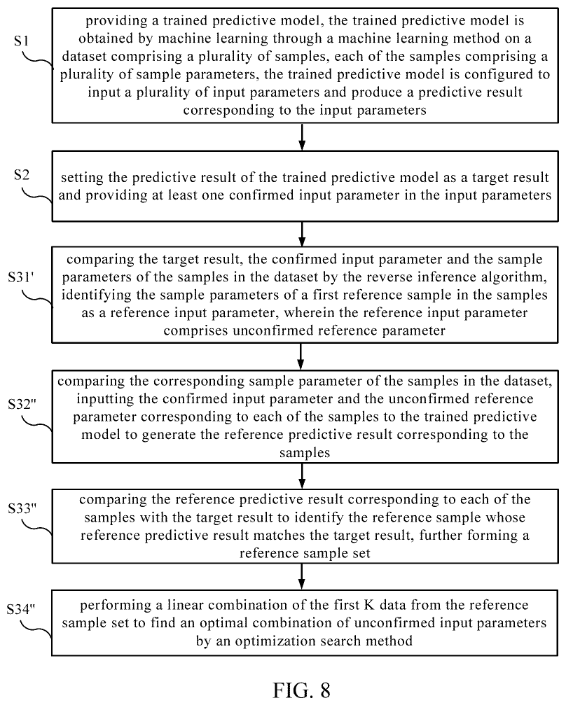

Furthermore, the method for calculating feasible process parameters of the invention can assume forms other than those previously described. Please refer to FIG. 7 and FIG. 8. FIG. 8 is a flowchart diagram illustrating a method for calculating feasible process parameters according to another embodiment of the present invention. As shown in FIG. 7, the present embodiment differs from the above embodiment in that the method for calculating feasible process parameters of the present embodiment can include step S34″, executed following step S33″. Step S34″: performing a linear combination of the first K data from the reference sample set to find an optimal combination of unconfirmed input parameters using an optimization search method. In this embodiment, the users sort the process reference samples in the set of the process reference samples by one-time comparison of the process dataset and find an optimal combination of unconfirmed input parameters with an optimization search method and by linearly combining the first K data in the set of the process reference samples with the user-defined condition limits. In practice, the users can set conditions based on their inventory of consumables and cost considerations, further sorting the set of process reference samples to select the most suitable reference samples that meet the user needs and target results using an optimization search method. In practice, the optimization search methods can include the Finite-Difference Method, Gradient Descent, Newton's Method, Penalty Function Method, Barrier Function Method, Lagrange Multiplier Method, or other computational methods chosen based on the user needs. Note that the other steps in the method for calculating feasible process parameters of the present embodiment are substantially similar to those described in the previous embodiments and would not be described again herein.

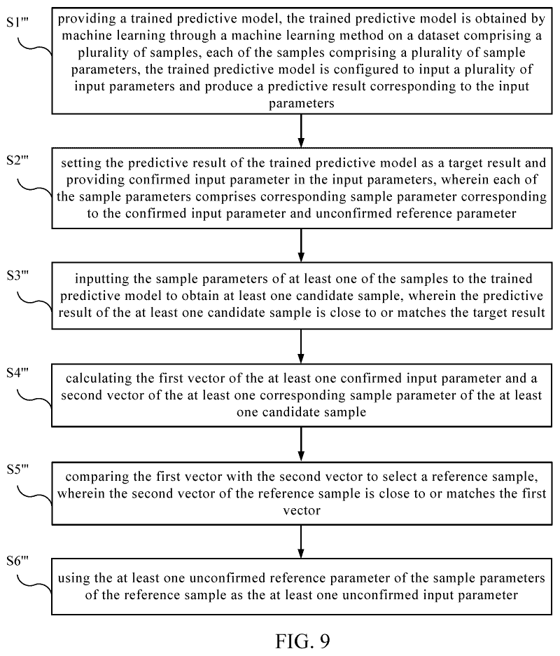

The method for calculating feasible process parameters of the present invention can be other than the above mentioned patterns, which will be further explained below. Please refer to FIG. 9. FIG. 9 is a flowchart diagram illustrating a method for calculating feasible process parameters according to another embodiment of the present invention. As shown in FIG. 9, in this embodiment, the method for calculating feasible process parameters includes the following steps: step S1″Δ: providing a trained predictive model, the trained predictive model being obtained by machine learning through a machine learning method on a dataset comprising a plurality of samples, each of the samples comprising a plurality of sample parameters, the trained predictive model being configured to input a plurality of input parameters and produce a predictive result corresponding to the input parameters; step S2″Δ: setting the predictive result of the trained predictive model as a target result and providing confirmed input parameter in the input parameters, wherein each of the sample parameters comprises corresponding sample parameter corresponding to the confirmed input parameter and unconfirmed reference parameter; step S3″Δ: inputting the sample parameters of at least one of the samples to the trained predictive model to obtain at least one candidate sample, wherein the predictive result of the at least one candidate sample is close to or matches the target result; step S4″Δ: calculating a first vector of the at least one confirmed input parameter and a second vector of the at least one corresponding sample parameter of the at least one candidate sample; step S5″Δ: comparing the first vector with the second vector to select a reference sample, wherein the second vector of the reference sample is close to or matches the first vector; step S6″Δ: using the at least one unconfirmed reference parameter of the sample parameters of the reference sample as the at least one unconfirmed input parameter.

The method for calculating feasible process parameters in the present embodiment differs from the previously described embodiment in that the present embodiment involves directly inputting the corresponding sample parameters and unconfirmed reference parameters from each of the samples in the dataset into the trained predictive model to obtain a predictive result. Additionally, when the predictive result of a sample in the dataset matches the target result, the sample can be considered a candidate sample. Subsequently, by calculating and comparing the first vector of the confirmed input parameters and the second vector of the corresponding sample parameters of the candidate sample, a sample whose second vector is close to or matches the first vector is selected as a reference sample. The unconfirmed reference parameters corresponding to the reference sample can serve as the unconfirmed input parameters for this process. In practice, the method for calculating feasible process parameters is suitable for processes involving large datasets by identifying the reference samples from the sample dataset whose predicted result matches or is close to the target result and whose second vector matches or is close to the first vector. In this case, there is no need to perform the step of inputting the combination of the unconfirmed reference parameters and the confirmed input parameters into the trained predictive model so that the unconfirmed input parameters of the process can be obtained efficiently and quickly. Note that the other steps in the method for calculating feasible process parameters of the present embodiment are substantially similar to those described in the previous embodiments, and would not be described again herein.

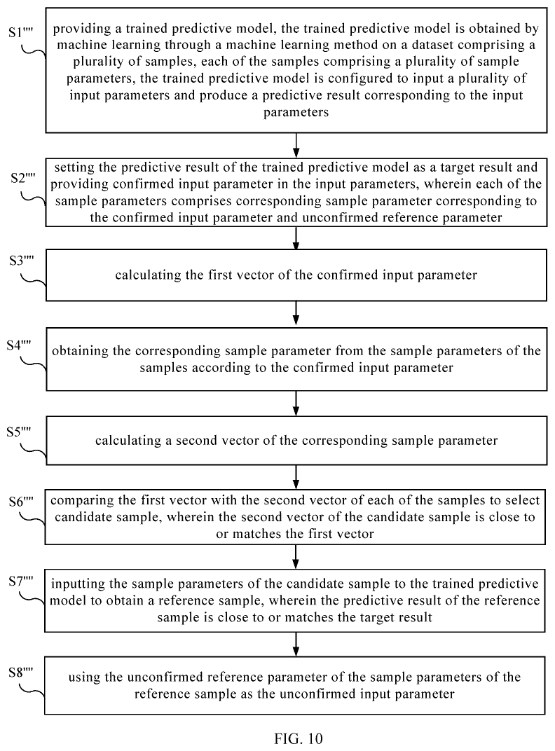

Furthermore, the method for calculating feasible process parameters in the present invention can take additional forms. Please refer to FIG. 10. FIG. 10 is a flowchart diagram illustrating a method for calculating feasible process parameters according to another embodiment of the present invention. As shown in FIG. 10, in this embodiment, the method includes the following steps: step S1ΔΔ: providing a trained predictive model, the trained predictive model being obtained by machine learning through a machine learning method on a dataset comprising a plurality of samples, each of the samples comprising a plurality of sample parameters, the trained predictive model being configured to input a plurality of input parameters and produce a predictive result corresponding to the input parameters; step S2ΔΔ: setting the predictive result of the trained predictive model as a target result and providing confirmed input parameter in the input parameters, wherein each of the sample parameters comprises corresponding sample parameter corresponding to the confirmed input parameter and unconfirmed reference parameter; step S3ΔΔ: calculating a first vector of the confirmed input parameter; step S4ΔΔ: obtaining the corresponding sample parameter from the sample parameters of the samples according to the confirmed input parameter; step S5ΔΔ: calculating a second vector of the corresponding sample parameter; step S6ΔΔ: comparing the first vector with the second vector of each of the samples to select candidate sample, wherein the second vector of the candidate sample is close to or matches the first vector; step S7ΔΔ: inputting the sample parameters of the candidate sample to the trained predictive model to obtain a reference sample, wherein the predictive result of the reference sample is close to or matches the target result; and step S8ΔΔ: using the unconfirmed reference parameter of the sample parameters of the reference sample as the unconfirmed input parameter. The method for calculating feasible process parameters in the present embodiment differs from the previously described embodiment in that the present embodiment compares the first vector with the second vector of the samples and then compares the predicted results with the target results so that the unconfirmed input parameters of the process can be obtained more accurately than in the previous embodiment. Note that the other steps in the method for calculating feasible process parameters of the present embodiment are substantially similar to those described in the previous embodiments and would not be described again herein.

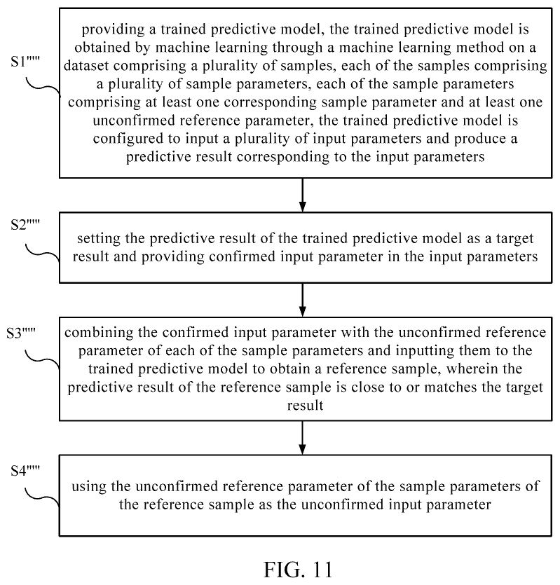

The method for calculating feasible process parameters in the present invention can be taken further to other forms. Please refer to FIG. 11. FIG. 11 is a flowchart diagram illustrating a method for calculating feasible process parameters according to another embodiment of the present invention. As shown in FIG. 11, in this embodiment, the method includes the following steps: step S1″ΔΔ: providing a trained predictive model, the trained predictive model being obtained by machine learning through a machine learning method on a dataset comprising a plurality of samples, each of the samples comprising a plurality of sample parameters, each of the sample parameters comprising at least one corresponding sample parameter and at least one unconfirmed reference parameter, the trained predictive model being configured to input a plurality of input parameters and produce a predictive result corresponding to the input parameters; step S2″ΔΔ: setting the predictive result of the trained predictive model as a target result and providing confirmed input parameter in the input parameters; step S3″ΔΔ: combining the confirmed input parameter with the unconfirmed reference parameter of each of the sample parameters and inputting them to the trained predictive model to obtain a reference sample, wherein the predictive result of the reference sample is close to or matches the target result; and step S4″ΔΔ: using the unconfirmed reference parameter of the sample parameters of the reference sample as the unconfirmed input parameter. The method for calculating feasible process parameters in the present embodiment differs from the previously described embodiment in that the present embodiment does not need to compare the first vector with the second vector of each of the samples but directly combines the confirmed input parameters with the unconfirmed reference parameters of each of the samples, and inputs them into the trained predictive model to obtain the predictive results, and then obtains the reference samples based on whether or not the predictive results of each of the samples are close to or match the target results. Compared to previous embodiments that obtain reference samples in two stages, the present embodiment only requires one stage to get the reference sample and conduct a comprehensive comparison to find the optimal solution. Note that the other steps in the method for calculating feasible process parameters of the present embodiment are substantially similar to those described in the previous embodiments and would not be described again herein.

In summary, the present invention provides a method for calculating feasible process parameters that effectively optimizes the process and achieves the target result of the process by inputting the expected target result and the confirmed input parameters and inverting the unconfirmed input parameters through the dataset of the trained predictive model. Furthermore, the present invention provides a method for calculating feasible process parameters that can be applied to any trained machine learning model to invert its process parameters and unconfirmed input parameters, in addition to its application in the field of cell process.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for calculating feasible process parameters, comprising the steps of:
providing a trained predictive model, the trained predictive model being obtained by machine learning through a machine learning method on a dataset comprising a plurality of samples, each of the samples comprising a plurality of sample parameters, the trained predictive model being configured to input a plurality of input parameters and produce a predictive result corresponding to the input parameters;
setting the predictive result of the trained predictive model as a target result and providing at least one confirmed input parameter in the input parameters; and
comparing the target result, the at least one confirmed input parameter and the sample parameters of the samples in the dataset by a reverse inference algorithm to determine at least one unconfirmed input parameter in the input parameters.

2. The method for calculating feasible process parameters of claim 1, wherein the dataset further comprises a process dataset, the process dataset comprises a plurality of process samples, each of the process samples comprises a plurality of process sample parameters, and each of the process sample parameters comprises a source parameter and a culture parameter.

3. The method for calculating feasible process parameters of claim 2, wherein the source parameter of each of the process samples further comprises an attribute data of a source of each of the process samples.

4. The method for calculating feasible process parameters of claim 2, wherein the culture parameter of each of the process samples further comprises operation, tool, material, method and environment data for each of the process samples.

5. The method for calculating feasible process parameters of claim 1, wherein each of the sample parameters comprises at least one corresponding sample parameter and at least one unconfirmed reference parameter, and the step of comparing the target result, the at least one confirmed input parameter and the sample parameters of the samples in the dataset by the reverse inference algorithm to determine the at least one unconfirmed input parameter in the input parameters further comprises the following steps:
calculating a first vector of the at least one confirmed input parameter;
obtaining at least one corresponding sample parameter from the sample parameters of the samples according to the at least one confirmed input parameter;
calculating a second vector of the at least one corresponding sample parameter;
comparing the first vector with the second vector of each of the samples to select at least one candidate sample;
combining and inputting the at least one unconfirmed reference parameter of the at least one candidate sample with the at least one confirmed input parameter to the trained predictive model to obtain a reference sample, wherein the second vector of the reference sample is close to or matches the first vector, and the predictive result of the reference sample is close to or matches the target result; and
using the at least one unconfirmed reference parameter of the sample parameters of the reference sample as the at least one unconfirmed input parameter.

6. The method for calculating feasible process parameters of claim 5, wherein the step of comparing the first vector with the second vector of each of the samples to select the at least one candidate sample further comprises the following steps:
calculating an angle between the first vector and each of the second vectors of the samples, and selecting the sample corresponding to the second vector with a smallest angle with the first vector as the candidate sample.

7. The method for calculating feasible process parameters of claim 5, wherein the step of comparing the first vector with the second vector of each of the samples to select the at least one candidate sample further comprises the following steps:
calculating a distance between an endpoint coordinate of the first vector and an endpoint coordinate of the second vector of each of the samples with a distance function, and selecting the sample corresponding to the second vector with a smallest distance from the first vector as the candidate sample.

8. The method for calculating feasible process parameters of claim 1, wherein the trained predictive model is obtained through machine learning of the dataset with one of the following techniques: an Artificial Neural Network (ANN), a Convolutional Neural Network (CNN), a Recurrent Neural Network (RNN), a Decision Tree, a Support Vector Machine (SVM), a Random Forest, a K-Nearest Neighbors (KNN) algorithm, a K-Means Clustering, a Principal Component Analysis (PCA), a Linear Regression, a Logistic Regression, a Gradient Boosting Machine, a Deep Belief Network (DBN), a Recursive Neural Network (RecNN), Reinforcement Learning, an Autoencoder, a Gaussian Process, and a Complex Neural Network.

9. The method for calculating feasible process parameters of claim 1, wherein the step of comparing the target result, the at least one confirmed input parameter and the sample parameters of the samples in the dataset by the reverse inference algorithm to determine the at least one unconfirmed input parameter in the input parameters further comprises the following steps:
comparing the target result, the at least one confirmed input parameter and the sample parameters of the samples in the dataset by the reverse inference algorithm, identifying the sample parameters of a first reference sample in the samples as a reference input parameter, wherein the reference input parameter comprises at least one unconfirmed reference parameter;
inputting the at least one confirmed input parameter and the at least one unconfirmed reference parameter into the trained predictive model to generate a reference predictive result;
comparing the reference predictive result with the target result; and
determining the at least one unconfirmed reference parameter as the at least one unconfirmed input parameter when the reference predictive result matches the target result.

10. The method for calculating feasible process parameters of claim 9, further comprising the following step:
when the reference predictive result does not match the target result, excluding the first reference sample and again comparing the target result, the at least one confirmed input parameter and the sample parameters of the samples in the dataset by the reverse inference algorithm to obtain the sample parameters of a second reference sample in the samples as the reference input parameter.

11. The method for calculating feasible process parameters of claim 10, further comprising the following steps:
comparing the at least one corresponding sample parameter of the samples in the dataset, inputting the at least one confirmed input parameter and the at least one unconfirmed reference parameter corresponding to each of the samples into the trained predictive model to generate the reference predictive result corresponding to the samples;
comparing the reference predictive result corresponding to each of the samples with the target result to identify the reference sample whose reference predictive result matches the target result, further forming a reference sample set.

12. The method for calculating feasible process parameters of claim 11, further comprising the following step:
performing a linear combination of the first K data from the reference sample set to find an optimal combination of unconfirmed input parameters using an optimization search method.

13. A method for calculating feasible process parameters, comprising the steps of:
providing a trained predictive model, the trained predictive model being obtained by machine learning through a machine learning method on a dataset comprising a plurality of samples, each of the samples comprising a plurality of sample parameters, the trained predictive model being configured to input a plurality of input parameters and produce a predictive result corresponding to the input parameters;
setting the predictive result of the trained predictive model as a target result and providing at least one confirmed input parameter in the input parameters, wherein each of the sample parameters comprises at least one corresponding sample parameter corresponding to the at least one confirmed input parameter and at least one unconfirmed reference parameter;
inputting the sample parameters of at least one of the samples to the trained predictive model to obtain at least one candidate sample, wherein the predictive result of the at least one candidate sample is close to or matches the target result;
calculating a first vector of the at least one confirmed input parameter and a second vector of the at least one corresponding sample parameter of the at least one candidate sample;
comparing the first vector with the second vector to select a reference sample, wherein the second vector of the reference sample is close to or matches the first vector; and
using the at least one unconfirmed reference parameter of the sample parameters of the reference sample as the at least one unconfirmed input parameter.

14. A method for calculating feasible process parameters, comprising the steps of:
providing a trained predictive model, the trained predictive model being obtained by machine learning through a machine learning method on a dataset comprising a plurality of samples, each of the samples comprising a plurality of sample parameters, the trained predictive model being configured to input a plurality of input parameters and produce a predictive result corresponding to the input parameters;
setting the predictive result of the trained predictive model as a target result and providing at least one confirmed input parameter in the input parameters, wherein each of the sample parameters comprises at least one corresponding sample parameter corresponding to the at least one confirmed input parameter and at least one unconfirmed reference parameter;
calculating a first vector of the at least one confirmed input parameter;
obtaining the at least one corresponding sample parameter from the sample parameters of the samples according to the at least one confirmed input parameter;
calculating a second vector of the at least one corresponding sample parameter;
comparing the first vector with the second vector of each of the samples to select at least one candidate sample, wherein the second vector of the at least one candidate sample is close to or matches the first vector;
inputting the sample parameters of the at least one candidate sample to the trained predictive model to obtain a reference sample, wherein the predictive result of the reference sample is close to or matches the target result; and
using the at least one unconfirmed reference parameter of the sample parameters of the reference sample as the at least one unconfirmed input parameter.

15. A method for calculating feasible process parameters, comprising the steps of:
providing a trained predictive model, the trained predictive model being obtained by machine learning through a machine learning method on a dataset comprising a plurality of samples, each of the samples comprising a plurality of sample parameters, each of the sample parameters comprising at least one corresponding sample parameter and at least one unconfirmed reference parameter, the trained predictive model being configured to input a plurality of input parameters and produce a predictive result corresponding to the input parameters;
setting the predictive result of the trained predictive model as a target result and providing at least one confirmed input parameter in the input parameters;
combining the at least one confirmed input parameter with the at least one unconfirmed reference parameter of each of the sample parameters and inputting them to the trained predictive model to obtain a reference sample, wherein the predictive result of the reference sample is close to or matches the target result; and
using the at least one unconfirmed reference parameter of the sample parameters of the reference sample as the at least one unconfirmed input parameter.
